(19) United States
(12) Patent Application Publication
(10) Pub. No.: US 2021/0246985 A1
(43) Pub. Date: Aug. 12, 2021

(54) Felt Wiper Seal with Energized Spring

(71) Applicant: Greene Tweed Technologies, Inc., Wilmington, DE (US)

(72) Inventors: Steve Okladek, Bethlehem, PA (US); Mahidi Hassan, Lansdale, PA (US)

(21) Appl. No.: 17/174,332

(22) Filed: Feb. 11, 2021

Related U.S. Application Data
(60) Provisional application No. 62/972,968, filed on Feb. 11, 2020.

(51) Int. Cl. F16J 15/3232; F16J 15/3284

(52) U.S. Cl. CPC F16J 15/3232; F16J 15/3284

(57) ABSTRACT

A scraper seal assembly and a seal body therefor are disclosed, wherein the assembly, comprises: a radially extending seal body having in a longitudinal cross-section, an outer surface, an inner sealing surface for contacting a surface to be sealed and a first and a second side surface, wherein the first side surface defines a first inwardly extending channel configured to receive an absorbing seal and the second side surface defines a second inwardly extending channel configured to receive a biasing member, wherein a first portion of the second side surface of the seal body and the inner sealing surface define a scraper lip and a second portion of the second side surface of the seal body is configured for contacting a wall of a gland, and wherein a first portion of the first side surface of the seal body and the inner sealing surface are configured to allow fluid intake into the first inwardly extending channel and a second portion of the first side surface of the seal body is configured to contact a wall of a gland; a felt-ring seated within the first inwardly extending channel; and a biasing member seated within the second inwardly extending channel, wherein an annular channel may extend between the first inwardly extending channel and the inner sealing surface.

### BACKGROUND OF THE INVENTION

### Field of the Invention

The invention relates to a scraper seal for use various end applications including in a scraper seal assembly that provides a fluid retention function for retention of break-in fluid in addition to debris blocking function, and particularly such a scraper seal that is an energized seal.

### Description of Related Art

Wiper and/or scraper seals are known for use in the art that provide the feature of blocking debris while providing sealing against a shaft or rotational body. See, e.g., U.S. Pat. No. 4,094,518. Such seals have various designs but typically have one or more leading scraper radial lips extending from the seal. Such seals can be used alone or with other seals or seal assemblies, and prevent debris from impacting such other seals or assemblies.

A radial seal suitable for a scraper application is provided by the applicant herein as an energized seal, incorporating a metal bias “finger spring” in a polymer jacket. The spring acts in use to bias an angled scraper radial lip of the seal against the wall of the shaft, while the opposing radial lip is then biased toward the interior wall of a gland in which the seal is installed. Such a radial scraper seal is available as MSE® Seal from Greene, Tweed, Kulpsville, Pa. The spring incorporates metal which energizes the seal for enhanced performance. In a scraping function, it may be used in conjunction with another seal in an assembly should specific sealing functions be required. The seal jacket is a polytetrafluoroethylene (PTFE) jacket. Such seals have various end applications in both rotating and linear shaft hydraulic equipment in aerospace, automotive, mechanical, fuel controls, pumps, valves, gear boxes and in various other end applications where scraper seals many be employed.

Other energized seals are employed in assemblies used in hydraulic equipment for aircraft including with other sealing rings having specific grooves for use in such end applications as shown in U.S. Pat. No. 10,260,634.

Felt seals are known for use as optional backup washers in sealing applications and, without a specific construction to use the seal in a beneficial manner, can create dust and other issues within a system. However, felt washers are accommodated in various scraper seals, also within various exclusion seals for preventing debris from impacting sealing lips of seals in seal assembly, e.g., in automotive use. See, e.g., Australian Patent No. 604,623.

Scraper and other seals of various configurations, particularly when prepared of polymeric materials have an initial “break-in” period in which the seal body material is still conforming and properly seating within the seal. During this time, some amount of initial leakage of fluid may occur but disappears once the seal is properly seated.

Scraper seals are not themselves always intended to act as fluid-tight seals for withstanding large amounts of fluid retention or pressure, which would be addressed be a separate, in-board seal. However, some ability to improve the function of the overall seal assembly while minimizing parts and increasing performance is desired.

There is a need in the art for a simplified scraper design that helps to minimize the cost and parts of the design and that improves functionality of such seals for use in seal assemblies for dynamic sealing end applications and that resolves also issues related to initial seal leakage during a break-in period. There is further a need in the art to capture “break-in” fluid, while not impacting the ability to identify an actual seal leak once the seal is in full operation in a manner differentiated from leakage due to a “break-in” period.

### BRIEF SUMMARY OF THE INVENTION

Applicants have developed a seal assembly designed to reduce the occurrence of rework on flight lines by capturing fluid associated with a “break-in” period, while still allowing for detection of actual leaks in the system. Openings are provided within the seal on the inboard side of the scraper assembly to allow fluid volumes beyond the volume capable of being absorbed by a felt ring within the assembly to escape the assembly and be detected by an operator in the event of an actual leak, while also capturing a volume of fluid that would normally be associated with breaking in the seal assembly in use.

In a further embodiment, the seal body further comprises an annular channel through the seal body extending from the first inwardly extending channel to the inner sealing surface.

The invention provides a seal for use in a seal assembly comprising: a seal body having a radially extending longitudinal cross-section, an outer surface, an inner sealing surface for contacting a surface to be sealed and a first and a second side surface, wherein the first side surface defines a first inwardly extending channel configured to receive an absorbing seal and the second side surface defines a second inwardly extending channel configured to receive a biasing member; wherein a first portion of the second side surface of the seal body and the inner sealing surface define a scraper lip and a second portion of the second side surface of the seal body is configured for contacting a wall of a gland; and wherein a first portion of the first side surface of the seal body and the inner sealing surface are configured to allow fluid intake into the first inwardly extending channel and a second portion of the first side surface of the seal body is configured to contact a wall of a gland.

The seal body may comprise a polymeric material, for example, a polymeric material is selected from the group consisting of polytetrafluoroethylene, polyarylene polymers, polyarylene ether polymers, natural rubber, olefinic rubber, polyamides, polyimides, polyetherimides, fluorinated co-polymers, and polychlorotrifluoroethylene.

The inner sealing surface of the seal body is preferably configured to guide fluid or debris toward the first and the second inwardly extending channels. In one embodiment herein, the scraper lip is preferably angled inwardly toward a surface to be sealed. In such an embodiment, the second portion of the second side surface of the seal body may have a flange protruding transversely into the second inwardly extending channel so as to receive and contact a biasing member. Further, the first side surface may have a first and a second radiused section defining a mouth of the first inwardly extending channel. In one embodiment, the inner sealing surface may be angled inwardly as it meets the first portion of the first side surface towards a surface to be sealed.

The first side surface may define an inwardly extending wall having a generally circular shape and an inwardly extending curved portion to provide a fluid retaining area.

The second inwardly extending channel may be generally U-shaped.

The outer surface of the seal may be angled on each of its first and second end toward the first and second side surfaces respectively.

The invention further includes a scraper seal assembly, comprising: a seal body having a radially extending longitudinal cross-section, an outer surface, an inner sealing surface for contacting a surface to be sealed and a first and a second side surface, wherein the first side surface defines a first inwardly extending channel configured to receive an absorbing seal and the second side surface defines a second inwardly extending channel configured to receive a biasing member, wherein a first portion of the second side surface of the seal body and the inner sealing surface define a scraper lip and a second portion of the second side surface of the seal body is configured for contacting a wall of a gland, and wherein a first portion of the first side surface of the seal body and the inner sealing surface are configured to allow fluid intake into the first inwardly extending channel and a second portion of the first side surface of the seal body is configured to contact a wall of a gland; a felt ring seated within the first inwardly extending channel; and a biasing member seated within the second inwardly extending channel.

The seal body may comprise a polymeric material such as, for example, a polymeric material is selected from the group consisting of polytetrafluoroethylene, polyarylene polymers, polyarylene ether polymers, natural rubber, olefinic rubber, polyamides, polyimides, polyetherimides, fluorinated co-polymers, and polychlorotrifluoroethylene.

The inner sealing surface may preferably be configured to guide fluid or debris toward the first and the second inwardly extending channels. The scraper lip may be angled inwardly toward a surface to be sealed. Further, the inner sealing surface may be angled inwardly as it meets the first portion of the first side surface towards a surface to be sealed.

The second portion of the second side surface of the seal body may have a flange protruding transversely into the second inwardly extending channel so as to receive and contact the biasing member.

The first side surface may have a first and a second radiused section defining a mouth of the first inwardly extending channel.

The first side surface may define an inwardly extending wall having a generally circular shape and an inwardly extending curved portion to provide a fluid retaining area such that the felt ring is seated in the generally circular area between a mouth of the first inwardly extending channel and the fluid retaining area.

The second inwardly extending channel may be generally U-shaped and the biasing member is also generally U-shaped so that the center of the biasing member contacts the second inwardly extending channel and the bottom of the U-shape of the channel, but the channel provides some space around the legs of the biasing member.

The outer surface of the seal may be angled on each of its first and second ends toward the first and second side surfaces respectively.

In one embodiment, the biasing member is an energizing biasing member comprising a metal or metal alloy. In a further embodiment, the seal body further comprises an annular channel through the seal body extending from the first inwardly extending channel to the inner sealing surface.

The invention further includes a seal assembly comprising: a seal body comprising a radially extending seal body having in a longitudinal cross-section, an outer surface, an inner sealing surface for contacting a surface to be sealed and a first and a second side surface, wherein the first side surface defines a first inwardly extending channel configured to receive an absorbing seal and the second side surface defines a second inwardly extending channel configured to receive a biasing member; wherein a first portion of the second side surface of the seal body and the inner sealing surface define a scraper lip and a second portion of the second side surface of the seal body is configured for contacting a wall of a gland; wherein a first portion of the first side surface of the seal body and the inner sealing surface are configured to allow fluid intake into the first inwardly extending channel and a second portion of the first side surface of the seal body is configured to contact a wall of a gland; and wherein the seal body comprises an annular channel extending from the first inwardly extending channel to the inner sealing surface. The seal assembly may further comprise a felt ring seated within the first inwardly extending channel; and a biasing member seated within the second inwardly extending channel.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a top elevational view of an embodiment of a seal body according to the invention;

FIG. 1A is a perspective view of the seal body of FIG. 1;

FIG. 1B is a longitudinal cross-sectional view of the seal body of FIG. 1 taken along line 1B-1B;

FIG. 2 is an enlarged portion of the longitudinal cross-sectional view of the seal body according to FIG. 1 taken along ling 2-2 in a gland defined by a gland wall for sealing against a sealing surface;

FIG. 3 is a top elevational view of an embodiment of the seal body used in the seal assembly of FIG. 1;

FIG. 3A is a longitudinal cross-sectional view of the seal assembly of FIG. 3 taken along line 3A-3A; and

FIG. 4 is an enlarged portion of the longitudinal cross-sectional view of the seal assembly of FIG. 3 taken along line 4-4 in a gland defined by a gland wall for sealing against a sealing surface.

### DETAILED DESCRIPTION OF THE INVENTION

The invention provides a unique seal body and scraper seal assembly that incorporates therein the seal body for use in sealing assemblies that is capable of both providing a scraping functionality as well as a fluid retention capability for addressing an initial break-in period leakage of newly installed seals.

In the description herein, words like “inner” and “outer,” “upwardly” and “downwardly,” inwardly” and “outwardly,” “right” and “left” and “upper” and “lower,” and words of similar import refer to directions in the drawings for assisting in clarifying the features of the invention unless otherwise specified. With respect to “inner” and “outer” sealing directions, it is meant towards the sealing surface and away from the sealing surface. Further, “inwardly” extending and “outwardly” extending mean towards and away from the center of the sealing body respectively.

The seal body herein is preferably formed of a polymeric material, such as a fluorinated polymer, including, for example, polytetrafluorethylene, fluorinated co-polymers of tetrafluoroethylene (such as with hexafluoropropylene, polyalkyvinyl ethers and the like), polyarylene and polyarylene ether polymers, such as polyketones, polyetherketone, polyetherether ketones, polyetherketone ketone, polyamides, polyimides, polyetherimides, polysulfones, aramids, liquid crystalline polymers, olefinic rubbers (such as, for example polyethylene diene rubber and blends thereof), and polychlorotrifluoroethylene, and copolymers, blends, and alloys thereof, including modified or functionalized materials. The seal body may also be an elastomeric material such as natural rubber, olefinic rubbers, fluoroelastomers, perfluoroelastomers, silicones, and the like.

Such materials may include one or more fillers as are known in the art for forming such seals, including carbon black, compatibilizers, rheology agents, plasticizers, fluoroplastic particles, talc, graphite, glass, organic or synthetic fibers and other reinforcing agents, silica, barium sulfates, UV-absorbers, micro- or nanoparticles and other property enhancing materials. Elastomeric materials may also include curing agents prior to forming.

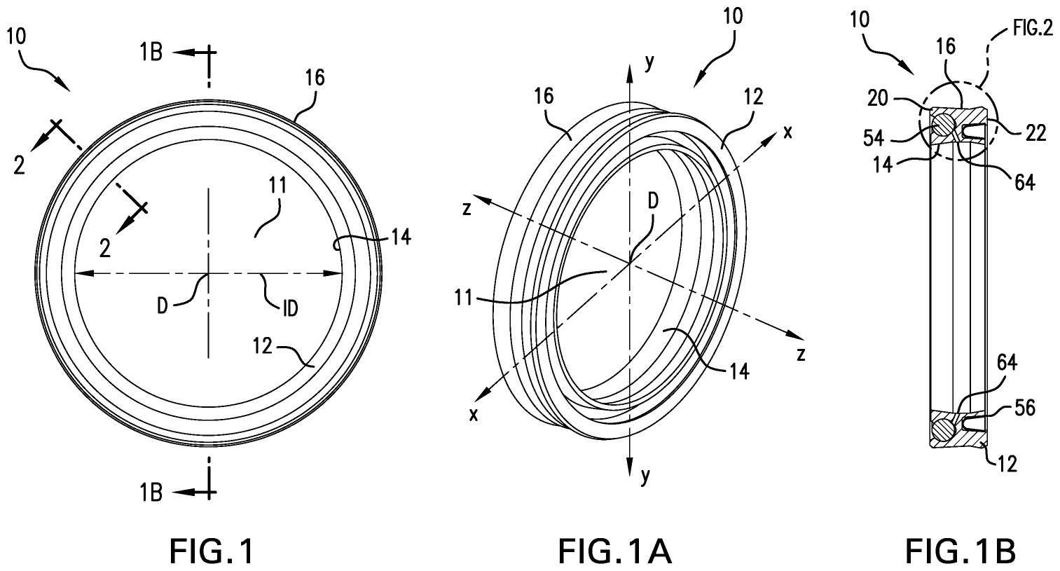

According to one embodiment herein as shown in FIGS. 1-4, a scraper seal assembly, generally referred to as assembly 10 is shown includes a seal body 12 that is radially extending and has a longitudinal cross-section as shown.

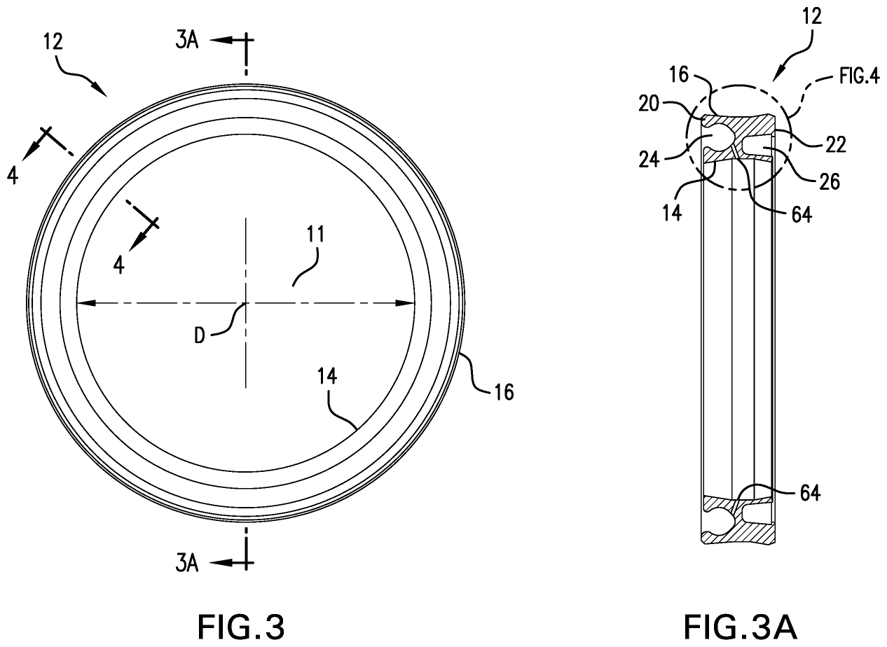

The seal body 12 is radially extending around a longitudinal axis through the central point D of the center area 11 of the seal body, shown as the z-axis in FIG. 1A with the seal body 12 extending radially in an x-y plane. The seal body is thus shown in a longitudinal cross-section in FIG. 1B as part of assembly 10 and in FIG. 3A, wherein it is shown as having an inner surface 14 and an outer surface 16. The inner surface is intended to face and/or contact a surface to be sealed (“sealing surface”) in at least partial facial engagement, or in full facial engagement in operation. A sealing surface to be sealed herein, designated, for example as surface 18 will depend on where, in an overall operational sealing assembly that includes the sealing assembly 10 herein the sealing assembly 10 is intended to be used. For example, if the sealing assemblies as used herein are positioned as the outermost sealing element, the inner surface 14 of the sealing body would preferably contact a surface of a part to be sealed on an atmospheric side of any assembly in which it is employed. If the seal body is a backup element behind an inner seal that contacts a part, then the inner surface of the seal body herein may contact a sealing surface by way of the outer surface of another seal (not shown) that then contacts a part (or other intervening seal(s) that contact a part). Thus, a sealing surface is shown in generic form herein as surface 18 as an example of a surface of a part P such as a piston. However, it will be understood by those skilled in the art, based on this disclosure, that the seal body 12 and seal assembly 10 herein and variants thereof can be used alone or in conjunction with another seal or seal assembly that would work with a scraper seal and/or that may experience break-in leakage during start-up of the seal in operation.

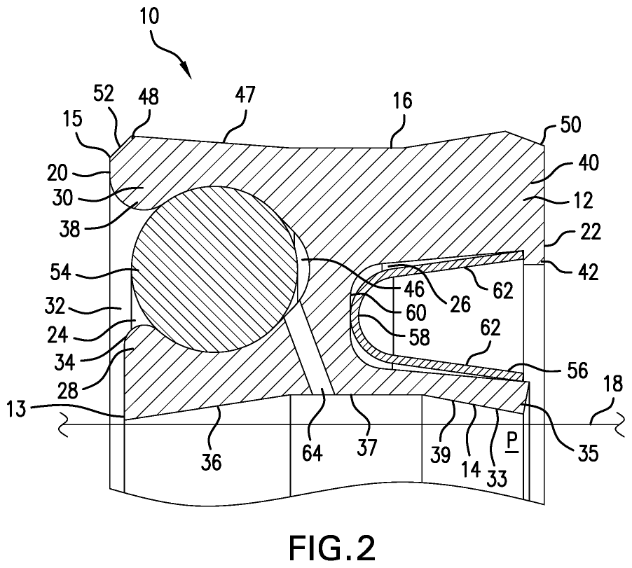

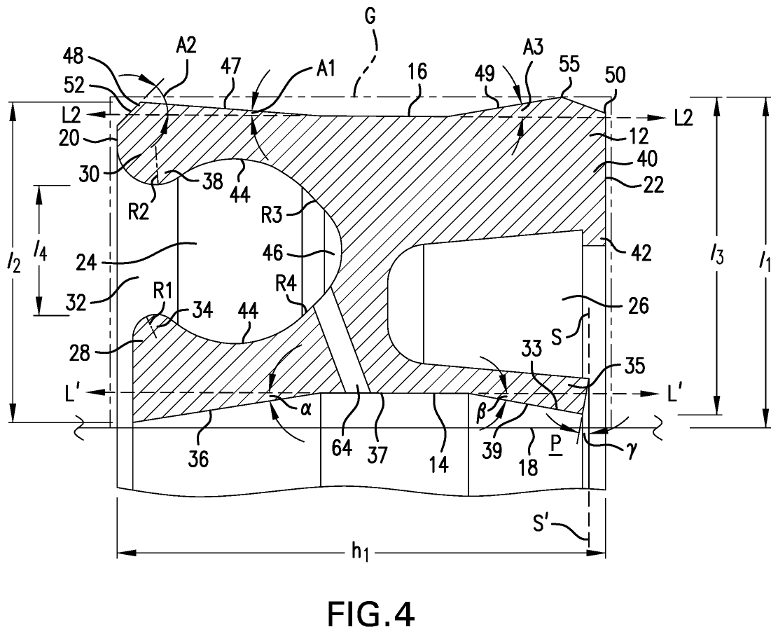

The seal body further has a first side surface 20 and a second side surface 22. The inner surface 14, outer surface 16, and side surfaces 20, 22 give the overall longitudinal cross-sectional shape of the seal body an overall generally rectangular profile as shown in FIGS. 2 and 4 in the preferred embodiment herein, however, other modified shapes may be adapted for use provided the functional benefits herein are provided. For example, a squarer shape, modified- or truncated-V shape, a more elliptical or oval shape, or polygonal shape could be formed, based on the disclosure herein, without departing from the spirit and scope of the invention.

Each of the first side surface 20 and the second side surface 22 is configured to have a profile that defines, respectively, a first inwardly extending channel 24 and second inwardly extending channel 26. The first side surface when positioned in a in one preferred use herein is situated to be an internal side of the seal for receiving fluid and the second side in a preferred use is on the atmospheric side of the seal to receive debris. The inwardly extending channels 24, 26 are configured within the first and second side surfaces 20, 22 respectively to receive support elements for functions of initial fluid retention and energized scraper functions, respectively. Thus, the first inwardly extending channel 24 is configured to allow fluid intake into the first inwardly extending channel and is preferably also configured to receive an absorbing seal such as a felt cord for example as described further below.

The first side surface 20 of the seal body 12 has a first portion 28 and a second portion 30 that are on inner and outer ends 13, 15 of the first side surface 20 and that surround the inwardly extending portion of surface 20 that defines the first inwardly extending channel 24. As best seen in FIG. 4, each of the first and the second portions 28, 30 of the first side surface 20 define a mouth 32 to the inwardly extending channel 24. The first portion 28 of the first side surface 20 of the seal body 12 and the inner sealing surface 14 together are configured to allow fluid intake over a first radiused section 34 having a radius R1. The radius R1 applied may vary, but in a preferred embodiment it is about 0.012 in. (0.030 cm) to about 0.018 in. (0.046 cm).

The first leg 36 of the inner surface 14 is angled from the side surface 20 inwardly towards the central portion 37 of the inner surface so that the angle formed by the first leg 36 of the inner surface of the seal and a line L′-L′ which is parallel to the longitudinal axis z-z of the seal body is an angle α of about 2° to about 6° taken from the central portion 37 of the inner surface of the seal toward the first side surface 20.

The inner sealing surface is preferably shaped as shown having two portions which are angled inwardly, i.e., on the left side of the inner surface 14, the surface is angled towards the central portion 37 of the inner surface of the seal as described above and the inner surface 14 is also angled inwardly from the second surface 22 of the seal body along a second leg 39 of the inner surface to shape the sloped portion and surface 33 of the scraper lip 36. The inner surface 14 in this angled area forms an angle β of about 8° to about 12° with respect to line L′-L′.

The second side surface 22 of the seal together with the inner surface 14 angled on the right-hand side as noted above are configured to define the scraper lip 36. The size and angled configuration of the scraper lip may be varied for different scraping functions, but preferably also is configured to receive a biasing member. As used herein, “biasing member” is intended to include a component part that is tensioned or energized to exert a force against a surface, in a preferred embodiment herein, an angled or cantilever spring is employed as a biasing member. However, it would be understood by one skilled in the art based on this disclosure that other similar biasing members (such as tubular, flexible hose, steel tubing or a traditional spring member) may also be used without departing from the spirit and scope of the invention.

The seal body 12 of assembly 10 in use, under pressure can contact a sealing surface fully or, partially along the angled downwardly sections of that surface 14 as shown in FIGS. 2 and 4. The inner surface 14 of the seal body 12 is also angled to drive fluid or debris within the moving part being sealed (or within a sealing assembly) towards the first inwardly extending channel 24 or second inwardly extending channel 26, respectively.

In initial break-in, discrete fluid leakage may travel over the first portion 28 of the first side surface 20 of the seal body 12 and would be directed by the radiused area 34 into the inwardly extending channel 24. Fluid is blocked from exiting the fluid retention area of the inwardly extending channel at the second end 15 in the second portion 30 of the first side surface 20, which preferably also has a radiused area 38. The radiused area 38 preferably has a radius R2 of about 0.116° to about 0.124°, but may be varied. Debris and other detritus or fragments and fluid may also be directed by the scraper lip 36 toward the second inwardly extending channel 26 but is blocked from exiting from the second portion 40 of the second side surface 22.

Thus, as configured and shown herein the inner surface, is configured to guide fluid, such as fluid from seal break-in leakage, or debris from operations toward the first and the second inwardly extending channels 24, 26, respectively.

The scraper lip 36 is also angled on the gland facing end (i.e., where the second surface 22 on the scraper lip is intended to contact the gland), at an angle γ of about 8° to about 12° with a line S′-S′ that is parallel to the transverse axis y-y through the seal. This angle allows for favorable operation and works with a biasing member within the seal positioned in the second inwardly extending channel 26.

The first and second side surfaces 20, 22, in some portion thereof, are preferably configured to contact the wall of a gland into which the seal body 12 may be placed.

The second portion 40 of the second side surface 22 of the seal body 12 preferably has a flange 42 that protrudes transversely along the seal body into the second inwardly extending channel 26 so as to better receive and interact with a biasing member upon installation.

The inwardly extending channel 24 may have varied shapes, but in the preferred embodiment shown, the channel 24 is generally circular in cross-sectional shape with a more generally circular portion 44 and two inward mild radiused portions R3 and R4 that help to receive an absorbing member in the generally circular portion, while also positioning it using the radiused sections noted to define a fluid retaining area 46 in inwardly located with respect to the generally circular area 44.

As shown, the second inwardly extending channel 26 is generally U-shaped but in a flattened U-profile that is not a smooth curve at its inward most point.

The outer surface 16 of the seal body contacts the first and second side surfaces 20, 22, respectively at a first end 48 and a second end 50 of the outer surface 16 as best shown in FIG. 4. In a manner similar to the inner surface, on a left-hand side of the outer surface in a first section 47 of the outer surface, the outer surface angles downwardly towards a central portion 45 of the outer surface 16 of the seal body. The downwardly angled first section 47 of the outer surface 16 angles downwardly forming an angle A1 between the outer surface 16 and a line L2-L2 that is parallel to the longitudinal axis of the seal as shown in FIG. 2 of about 1° to about 3°. The first surface 20 meets the first end 48 of the outer surface 16 at an angled corner 52. The corner 52 preferably forms an angle A2 of about 30° to about 50° with the line L2-L2 extending parallel to the longitudinal axis z-z through the seal.

On the opposite end 50 of the outer surface 16, a downwardly extending angle A3 is formed with line L2-L2 of about 8° to about 12° to assist the capability of the second side and channel 26 to collect debris. The seal body assembly may be part of a seal assembly, but is preferably situated on an atmospheric side of a seal body and may be displaced along a sealing surface from an operational seal or seal assembly.

The seal body as shown in FIG. 4 has various measurements including an overall height h₁ as shown in FIG. 4 extending in the longitudinal direction that may, in a preferred embodiment herein, range of about 0.308 in. (0.782 cm) to about 0.318 in. (0.808 cm) and an overall length l₁ measured longitudinally as shown of about 0.208 in. (0.528 cm) to about 0.216 in. (0.549 cm) as measured from the lowest end 13 of the first side surface 20 to a highest point 55 on the upper surface 16. The mouth of the opening to the first inwardly extending channel 24 is preferably about 0.080 in. (0.203 cm) to about 0.088 mm (0.224 cm) (l₄). The length of the first side surface 20 from the inwardly directed angled section 36 on the inner surface 14 to top of the side surface where it reaches the beginning of the first section 47 of the outer surface 16 of the seal body, at their highest point has a length l₂ of about 0.201 in. (0.511 cm) to about 0.213 in. (0.541 cm). The length measurement l₃ of the second side surface from a location on the second side surface 20 of the seal body that is from its highest point when meeting the angled portion 49 of the outer surface to the lower end of the angled portion 39 of the inner surface 14 of the seal body is about 0.199 in. (0.505 cm) to about 0.213 in. (0.541 cm). In the example seal body described, the inner diameter ID as shown in FIG. 1 is about 1.501 in. (3.813 cm) to about 1.511 in. (3.838 cm).

In a further embodiment herein, the seal body as noted above is employed in a seal assembly. In the seal assembly 10, the seal body 12 is further provided with a felt ring seated within the first inwardly extending channel. As shown in FIGS. 1B and 2, the felt ring 54 may be any suitably sized ring, preferably a ring have a generally circular longitudinal cross section. The felt ring 54 is preferably made of a sealing grade material such of that used to form felt washers or the like. Such materials are available commercially, for example, from McCaster Carr® As used herein, the felt ring has a diameter of about 0.243 in. (0.617 cm) to about 0.249 (0.633 cm) and can vary depending upon the size of the inwardly extending channel 24. The first inwardly extending channel 24 and the felt ring 54 should be configured together so that the felt ring 54 generally fills the channel, but absorbs break-in leakage which is absorbed in the absorbing felt fabric and may be retained therein and to the extent it exceeds that absorption would pass to the fluid retaining area 46 and be drained from the area as described below. Other fabric or absorbing rings may be used if the same function can be performed.

The assembly further includes a biasing member 56 seated within the second inwardly extending channel 26. The biasing member 56 should be shaped so as to fit within the second inwardly extending channel in a functionally complementary manner. As shown, the biasing member 56 is an energizing spring biasing member that is generally U-shaped. In the second inwardly extending channel 26, which is shown in the seal body 12 as a more truncated U-shape, the more curved U-shape provides a center 58 of the biasing member that contacts the second side surface 22 within the second inwardly extending channel at the bottom 60 of the “U” of the truncated U-shape of the channel 26. The second inwardly extending channel as shown is shaped to provide some flexibility and space for the biasing member to provide adequate force against the second side surface 22 within the channel 26 so that the legs 62 of the biasing member press toward the inner surface 14 of the seal from the outer side of the scraper lip 36 towards the inner surface 14 of the seal body 12, and press also toward the opposite outer side of the second inwardly extending channel with the end of the associated leg 62 of the biasing member contacting the transversely extending flange 42. The biasing member preferably comprises a metal or a metal alloy, and may be formed in various configurations (e.g., it may be a round or circular spring member).

The seal assembly is fitted with an annular channel 64 that angles through the seal extending between the inner surface 14 of the seal body to a portion of the inner channel 24 adjacent the retention area 46. After a break-in period, the felt ring 54 is designed to absorb any break-in liquid to avoid a mistaken presumption of leakage during break-in periods. However, after break-in periods, it is important that should there be an actual operational leak in a sealing body that is operationally protected by the scraper seal assembly 10, fluid needs to travel freely after passing into the channel, behind the felt ring 54 to pass out of the seal through the inner area 11 for normal operation so that a leak may be detected. For this purpose, the annular channel 64 enables normal operational flow of liquid while allowing the felt ring to absorb any extraneous break-in fluid.

The invention will now be explained with respect to the following non-limiting example.

### EXAMPLE

A sealing assembly was formed having the configuration shown in FIGS. 3-4 herein having a seal body that was of a height h₁ of about 0.313±0.005 in, a length l₂ of about 0.207±0.004 in., a mouth of about 0.084. The downwardly extending portion of the first side surface near the inner surface of the seal extended about 0019 in. from the central portion of the inner surface. The radius on each end of the felt seal was 0.015 in. on the first portion of the first side surface and 0.039 in. on the second portion of the first side surface with a tolerance of 0.003. The scraper leg extended downwardly toward the inner surface of the seal body about 0.023 in.

The seal was fitted with a felt cord including 34R1 (SAE J314 F-1 Wool Rolled Felt Sheet) that was 1.6 in its internal diameter and 0.125 in diameter. The biasing member was a metal spring energizer.

Two sample assemblies as described above, Samples 1 and 2 were tested against an industry available commercial MSE Seals scraper seal (having no absorbing felt ring) identified here as Comparative Samples 1 and 2.

The seals were placed in a test configuration with a top position having only a bearing without a seal and a bottom position having the test seal samples. 10 cubic centimeters in volume of oil (Skydrol) were used to test the seal.

The results in weight gain show the benefit of the fluid retention function in the test samples 1 and 2 according to the invention.

TABLE 1

| | | Oil Leakage (g) | | | | Net | Run |
|---|---|---|---|---|---|---|---|
| | | Top | Bottom | Test Seal (g) | | Weight | Time |
| Test # | Seal | (rig seal) | (Test seal) | Before | After | Gain | sec. |
| Comp. | MSE | 0.49 | 0.55 | 6.89 | 6.97 | 0.08 | 4 min. |
| 1 | | | | | | | |
| Comp. | MSE | 0.22 | 0.21 | 6.88 | 6.97 | 0.09 | 2 min. |
| 2 | | | | | | | |
| 1 | Felt | 0.09 | 0.04 | 7.65 | 8.30 | 0.65 | 2 min. |
| | Scraper | | | | | | |
| | MSE | | | | | | |
| 2 | Felt | 0.08 | 0.03 | 7.68 | 8.39 | 0.71 | 2 min. |
| | Scraper | | | | | | |
| | MSE | | | | | | |
| | | Oil Leakage (Drops) | | | | Net | Run |
| | | Top | Bottom | Test Seal (g) | | Weight | Time |
| Test # | Seal | (rig seal) | (Test seal) | Before | After | Gain | sec. |
| Comp. | MSE | 10.78 | 12.1 | 6.89 | 6.97 | 0.08 | 4 min. |
| 1 | | | | | | | |
| Comp. | MSE | 4.84 | 4.62 | 6.88 | 6.97 | 0.09 | 2 min. |
| 2 | | | | | | | |
| 1 | Felt | 1.98 | 0.88 | 7.65 | 8.30 | 0.65 | 2 min. |
| | Scraper | | | | | | |
| | MSE | | | | | | |
| 2 | Felt | 1.76 | 0.66 | 7.68 | 8.39 | 0.71 | 2 min. |
| | Scraper | | | | | | |
| | MSE | | | | | | |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A seal for use in a seal assembly comprising:
a radially extending seal body having in a longitudinal cross-section, an outer surface, an inner sealing surface for contacting a surface to be sealed and a first and a second side surface, wherein the first side surface defines a first inwardly extending channel configured to receive an absorbing seal and the second side surface defines a second inwardly extending channel configured to receive a biasing member;
wherein a first portion of the second side surface of the seal body and the inner sealing surface define a scraper lip and a second portion of the second side surface of the seal body is configured for contacting a wall of a gland; and
wherein a first portion of the first side surface of the seal body and the inner sealing surface are configured to allow fluid intake into the first inwardly extending channel and a second portion of the first side surface of the seal body is configured to contact a wall of a gland.

2. The seal body according to claim 1, wherein the seal body comprises a polymeric material.

3. The seal body according to claim 2, wherein the polymeric material is selected from the group consisting of polytetrafluoroethylene, polyarylene polymers, polyarylene ether polymers, natural rubber, olefinic rubber, polyamides, polyimides, polyetherimides, fluorinated co-polymers, and polychlorotrifluoroethylene.

4. The seal body according to claim 1, wherein the inner sealing surface is configured to guide fluid or debris toward the first and the second inwardly extending channels.

5. The seal body according to claim 4, wherein the scraper lip is angled inwardly toward a surface to be sealed.

6. The seal body according to claim 4, wherein the second portion of the second side surface of the seal body has a flange protruding transversely into the second inwardly extending channel so as to receive and contact a biasing member.

7. The seal body according to claim 4, wherein the first side surface has a first and a second radiused section defining a mouth of the first inwardly extending channel.

8. The seal body according to claim 4, wherein the inner sealing surface may be angled inwardly as it meets the first portion of the first side surface towards a surface to be sealed.

9. The seal body according to claim 1, wherein the first side surface defines an inwardly extending wall having a generally circular shape and an inwardly extending curved portion to provide a fluid retaining area.

10. The seal body according to claim 1, wherein the second inwardly extending channel is generally U-shaped.

11. The seal body according to claim 1, wherein the outer surface of the seal is angled on each of its first and second end toward the first and second side surfaces respectively.

12. The seal body according to claim 1, further comprising an annular channel through the seal body extending from the first inwardly extending channel to the inner sealing surface

13. A scraper seal assembly, comprising:
a radially extending seal body having in a longitudinal cross-section, an outer surface, an inner sealing surface for contacting a surface to be sealed and a first and a second side surface, wherein the first side surface defines a first inwardly extending channel configured to receive an absorbing seal and the second side surface defines a second inwardly extending channel configured to receive a biasing member, wherein a first portion of the second side surface of the seal body and the inner sealing surface define a scraper lip and a second portion of the second side surface of the seal body is configured for contacting a wall of a gland, and wherein a first portion of the first side surface of the seal body and the inner sealing surface are configured to allow fluid intake into the first inwardly extending channel and a second portion of the first side surface of the seal body is configured to contact a wall of a gland;
a felt ring seated within the first inwardly extending channel; and
a biasing member seated within the second inwardly extending channel.

14. The scraper seal assembly according to claim 13, wherein the seal body comprises a polymeric material.

15. The scraper seal assembly according to claim 14, wherein the polymeric material is selected from the group consisting of polytetrafluoroethylene, polyarylene polymers, polyarylene ether polymers, natural rubber, olefinic rubber, polyamides, polyimides, polyetherimides, fluorinated co-polymers, and polychlorotrifluoroethylene.

16. The scraper seal assembly according to claim 13, wherein the inner sealing surface is configured to guide fluid or debris toward the first and the second inwardly extending channels.

17. The scraper seal assembly according to claim 16, wherein the scraper lip is angled inwardly toward a surface to be sealed.

18. The scraper seal assembly according to claim 16, wherein the second portion of the second side surface of the seal body has a flange protruding transversely into the second inwardly extending channel so as to receive and contact the biasing member.

19. The scraper seal assembly according to claim 16, wherein the first side surface has a first and a second radiused section defining a mouth of the first inwardly extending channel.

20. The scraper seal assembly according to claim 16, wherein the inner sealing surface may be angled inwardly as it meets the first portion of the first side surface towards a surface to be sealed.

21. The scraper seal assembly according to claim 13, wherein the first side surface defines an inwardly extending wall having a generally circular shape and an inwardly extending curved portion to provide a fluid retaining area such that the felt ring is seated in the generally circular area between a mouth of the first inwardly extending channel and the fluid retaining area.

22. The scraper seal assembly according to claim 13, wherein the second inwardly extending channel is generally U-shaped and the biasing member is also generally U-shaped so that the center of the biasing member contacts the second inwardly extending channel and the bottom of the U-shape of the channel, but the channel provides some space around the legs of the biasing member.

23. The scraper seal assembly according to claim 13, wherein the outer surface of the seal is angled on each of its first and second end toward the first and second side surfaces respectively.

24. The scraper seal assembly according to claim 13, wherein the biasing member is an energizing biasing member comprising a metal or metal alloy.

25. The scraper seal assembly according to claim 13, further comprising an annular channel through the seal body extending from the first inwardly extending channel to the inner sealing surface

26. A seal assembly comprising:
a seal body comprising a radially extending seal body having in a longitudinal cross-section, an outer surface, an inner sealing surface for contacting a surface to be sealed and a first and a second side surface, wherein the first side surface defines a first inwardly extending channel configured to receive an absorbing seal and the second side surface defines a second inwardly extending channel configured to receive a biasing member;
wherein a first portion of the second side surface of the seal body and the inner sealing surface define a scraper lip and a second portion of the second side surface of the seal body is configured for contacting a wall of a gland;
wherein a first portion of the first side surface of the seal body and the inner sealing surface are configured to allow fluid intake into the first inwardly extending channel and a second portion of the first side surface of the seal body is configured to contact a wall of a gland; and
wherein the seal body comprises an annular channel extending from the first inwardly extending channel to the inner sealing surface.

27. The seal assembly according to claim 26, further comprising a felt ring seated within the first inwardly extending channel; and a biasing member seated within the second inwardly extending channel.
